(19) United States
(12) Patent Application Publication
(10) Pub. No.: US 2007/0071900 A1
(43) Pub. Date: Mar. 29, 2007

(54) Methods for protecting metal surfaces

(76) Inventors: Philippe Soussan, Leuven (BE); Serguei Stoukatch, Leuven (BE); Eric Beyne, Leuven (BE)

Correspondence Address: KNOBBE MARTENS OLSON & BEAR LLP, 2040 MAIN STREET, FOURTEENTH FLOOR, IRVINE, CA, 92614, US

(21) Appl. No.: 11/527,303

(22) Filed: Sep. 25, 2006

Related U.S. Application Data
(60) Provisional application No. 60/722,609, filed on Sep. 29, 2005.
(60) Provisional application No. 60/727,211, filed on Oct. 14, 2005.

(51) Int. Cl. B05D 3/00; B05D 3/02

(52) U.S. Cl. 427/372.2; 427/532; 438/758

(57) ABSTRACT

Methods for protecting metal surfaces against oxidation are provided. The methods can comprise a plasma treatment, a sintering treatment or a combination of the plasma and sintering treatment. Also provided is a method for bonding a wire on a metal bond pad using the methods for protecting a metal surface.

### CROSS-REFERENCE TO RELATED APPLICATIONS

This application claims the benefit under 35 U.S.C. § 119(e) of U.S. provisional application Ser. No. 60/722,609, filed Sep. 29, 2005, and U.S. provisional application Ser. No. 60/727,211, filed Oct. 14, 2005, the disclosures of which are hereby incorporated by reference in their entirety and are hereby expressly made a portion of this application.

### FIELD OF THE INVENTION

Methods for protecting a metal surface against oxidation are provided, as well as a method for bonding wires to metal bond pads using the methods for protecting a metal surface. A typical application domain is the field of bonding metal bonding wires to metal bond pads in e.g. microelectronics technology.

### BACKGROUND OF THE INVENTION

In high-performance and advanced semiconductor devices, the trend toward copper metallization is progressing. Implementation of copper instead of aluminium as interconnect material increases the integrated circuit performance and reduces electromigration phenomenon. Similarly, copper and copper based alloys are replacing aluminum as the material for bond pad's finish metallization, because of their outstanding properties.

A general treatment used to prepare or protect copper surfaces for further processing is to perform an annealing in chemically reducing atmospheres (e.g., forming gas (N₂/H₂)). This technique restores the pure copper surface by reducing the copper oxide present at the copper surface. However, the surface will re-oxidize when exposed to oxidizing ambient afterwards.

Copper and copper based alloys already oxidize in air at room temperature. Thermal exposure, which is a common attribute for wire bonding, makes this even worse. In these cases, the oxide continues to grow in thickness on the copper bond pad. Therefore, the condition of the copper surface is a crucial factor for successfully performing a wire bonding process. With successful wire bonding process is meant that after bonding the wire to the bond pad, a tight contact is obtained between the wire and the bond pad. To achieve successful wire bonding on copper bond pads, it is necessary to protect the top surface of the pads from oxidation.

For providing a pure Cu surface in advanced microelectronics, mainly three different approaches are being used today.

One approach consists of a physical protection of copper, realized by coating the copper surface by materials that are not sensitive to oxidation and that exhibit good diffusion barrier properties towards oxidizing elements (more details below).

A second approach consists of physically removing copper oxides present at the copper surface by, e.g., chemical etching in hydrochloric acid (HCl) or acetic acid (CH₃CO₂H), which has proved to selectively etch the copper oxide without attacking the underlying copper surface. Because copper is very sensitive to oxidation in the presence of water, dry techniques are usually preferred. Argon based plasma processes are commonly used for this purpose. This technique removes the copper oxides, and possibly also the copper itself depending on the etch time, by means of sputtering phenomena. It further activates the surface and is commonly used in wire bonding to increase adhesion of a bond wire to a bond pad. Due to the re-oxidation process of the surface, wire bonding performance is reduced over time, which means that surfaces need to be processed within a 15 minutes process window.

A third approach consists in chemically reducing the copper oxides, which is achieved by exposing the oxidized copper surface to reducing agents. Ethanol vapour or ethyl alcohol is efficiently used for this purpose. Similarly, plasmas in forming gases are commonly used. Such techniques in fact combine a chemical reaction, i.e. the reduction of copper oxide, with a physical removal, which is inherent to ionic bombardment of the substrate by energetic particles.

They can be performed at room temperature with a limited success.

In the second and third approach, one is always limited by the re-oxidation process that occurs naturally to the pure copper surface.

In wire bonding technology, the copper bond pad needs to be protected from oxidation. This can be achieved with various techniques, such as metallurgical capping (the most known among them, are Ni/Au, Ni/Pd/Au and Al), thin organic films (self assembled mono layer, OSP: known as organic surface preservative), thin inorganic films (SiC or thin titanium passivation layer), or plasma cleaning technique directly prior to wire bonding. All these methods have several disadvantages.

Metal caps provide the best known results up till now for the protection of copper surfaces against oxidation. However, these metal caps introduce an additional interface on top of the copper bond pads. This minimizes the electrical performance improvement gained by replacing aluminum bond pad metallization by copper metallization. In addition, it may cause significant reliability deterioration. The application of these metal caps is done by plating or vacuum deposition techniques, which increase the wafer fabrication lead-time and make the end product very expensive.

The use of thin organic films for copper oxidation protection is a relatively cheap and simple process. The most successful among them is the application of self-assembled monolayers (SAMs). SAMs are easy to apply at wafer level by spinning or dipping techniques, but the wafer comprising e.g. a copper surface needs to be conditioned by a wet cleaning process before the application of the SAM. SAM layers are very thin (below 50 nm thick) and soft, and can easily be removed by ultrasonic power during thermosonic (TS) wire bonding, ultimately resulting in a good bonding performance. However, the method has several drawbacks, the main one being the limited stability with respect to thermal exposure.

Thin inorganic films are also used for copper oxidation protection (e.g. SiC, SiO, SiON or “thin titanium passivation layer”). In general, these layers provide sufficient copper protection against oxidation. However, in many cases the passivation layer cannot be removed by ultrasonic power during thermosonic wire bonding or requires excessive ultrasonic power that, as was reported, may damage the soft and sensitive low-k dielectric, which may be present underneath.

In order to prevent the copper surface from oxidation, it is possible to use thermosonic wire bonding to bare copper by use of an inert gas environment. The inert gas environment, usually argon or nitrogen, is applied locally onto the bonding area and creates a shielding atmosphere to protect copper surfaces against oxidation, which enables and secures a stable wire bonding process within 5 to 20 minutes.

In U.S. Pat. No. 6,720,204 B2, a method of bonding a wire to a metal bond pad is disclosed, comprising the following steps. A semiconductor die structure having an exposed metal bond pad is provided within a chamber. The bond pad has an upper surface. A hydrogen-plasma is produced within the chamber from a plasma source. The metal bond pad is pre-cleaned and passivated with the hydrogen-plasma to remove any metal oxide formed on the metal bond pad upper surface. A wire is then bonded to the passivated metal bond pad while the metal bonding path is within the hydrogen comprising plasma. FIG. 1 illustrates a tool for performing the method according to U.S. Pat. No. 6,720,204 B2. The tool comprises a plasma tool 102, a bonding tool 104 and a transfer mechanism 106 by which a wafer is transported between the plasma tool 102 and the bonding tool 104. The plasma tool 102, bonding tool 104 and transfer mechanism 106 are located in an enclosure 100 which is purged with N₂, which forms a non-oxidizing environment for preventing oxidation of the bond pads during transportation of the semiconductor die structure from the plasma tool 102 to the bonding tool 104.

### SUMMARY OF THE INVENTION

A good method for protecting a metal surface against oxidation which alleviates or avoids the problems of the prior art is provided. The method enables long term prevention of oxidation of surfaces comprising metals and metal alloys such as e.g. copper or copper based alloys, enabling further processing without suffering from the presence of a metal oxide, e.g. copper oxide.

A method for wire bonding on metal bond pads, such as e.g. Cu bond pads, at large scale is also provided.

Methods are provided for treating or protecting metal surfaces against oxidation. Such a metal surface can be, for instance, a metal bond pad on a semiconductor device, on which e.g. a wire needs to be bond for electrically connecting the semiconductor device with components external to the semiconductor device. Methods for cleaning, passivation and protection of such a surface, which allow further processing of the metal surface without suffering from oxidation, are also provided. For example, bonding of wires onto the metal surface can be possible at a later stage, especially after placing the metal surfaces in an oxidizing environment as, for instance, air without oxidation of the metal surface.

In a first aspect, a method for protecting a metal surface is disclosed, comprising the steps of: providing the metal surface within a plasma chamber; producing a hydrogen comprising plasma within the plasma chamber; treating the metal surface with the hydrogen comprising plasma whereby the metal surface is at a temperature above 150° C. for completely removing oxides present at the metal surface and for hydrogenating the metal surface; and removing the metal surface from the plasma chamber into an oxidizing environment.

The method according to preferred embodiments of the first aspect allows bringing the treated metal surfaces outside the plasma chamber, e.g. in an oxidizing environment or ambient air, for a significant amount of time, without oxidation of the metal surface occurring and thus after which further processing, e.g. wire bonding, can still be successfully performed without any oxidation removal steps being necessary. This offers an additional degree of freedom in production processes and a wide range of new production possibilities. For instance, metal surfaces treated according to the method of the first aspect can be stored in air for a while or can be transported outside a non-oxidizing atmosphere without oxidation of the metal surface.

According to certain embodiments the metal surface can comprise Cu or Ag.

According to preferred embodiments of the first aspect, the temperature of the metal surface is brought to a temperature of from 30° C. to 400° C., more preferably from 70° C. to 300° C., even more preferably from 125° C. to 200° C. or from 150° C. to 400° C., preferably from 150° C. to 300° C. and more preferably from 150° C. to 300° C., while treated or before being treated with the hydrogen comprising plasma. According to certain embodiments the metal surface can be put on a heatable chuck when in the plasma chamber, which can reduce the process duration.

According to preferred embodiments of the first aspect, the plasma gas for forming the hydrogen comprising plasma can comprise H₂ and/or NH₃. The fraction of plasma gas comprising H₂ and/or NH₃ is preferably from 100% to 20%, more preferably from 90% to 70%.

According to preferred embodiments of the first aspect, the plasma gas can comprise N₂, O₂, Ar or He, or other noble gases, or a combination of the aforementioned gases. The fraction of plasma gas comprising N₂, O₂, Ar or He, or other noble gases or a combination of the aforementioned gases is from 0% to 30%, preferably from 10 to 30%.

The method according to preferred embodiments allows the metal surface to be stored in an oxidizing environment for a period of more than 1, 8, 12, 24, 48 hours.

According to preferred embodiments of the first aspect, a hydrogen comprising plasma can be generated by an Inductively Coupled Plasma-Reactive ion etching or ICP-RIE tool. According to preferred embodiments of the first aspect, power supplied to a coil used in the ICP-RIE tool, also called ICP parameter, can be from 300 to 1000 W. According to preferred embodiments of the first aspect, the direct power or RIE parameter can be from 50 to 250 W.

In preferred embodiments of the first aspect, the hydrogen comprising plasma can be generated by microwave downstream plasma equipment.

According to preferred embodiments of the first aspect, wherein the Microwave power (for downstream plasma) can be from 200 to 3000 W.

According to preferred embodiments of the first aspect, treating the metal surface with a hydrogen comprising plasma can have a duration of from 30 to 120 seconds, preferably from 60 to 120 seconds.

According to preferred embodiments of the first aspect, injection of gas into the plasma chamber for forming the hydrogen comprising plasma can be from 50 sccm to 600 sccm.

In a second aspect, a method of bonding a wire to an exposed metal bond pad on a wafer is disclosed, comprising the steps of treating the metal bond pad according to any of the methods for protecting a metal surface according to the preferred embodiments; and bonding a wire to the treated metal bond pad after having moved the wafer into an oxidizing environment.

The method according to the second aspect enables bringing the semiconductor die structure or wafer outside the plasma chamber, e.g. in an oxidizing environment or ambient air, for a significant amount of time, without oxidation of the metal surface occurring and thus after which further processing, in this aspect wire bonding, can still advantageously be performed. This offers an additional degree in production processes and a wide range of new production possibilities. For instance, semiconductor die structures or wafers comprising a metal surface treated according to the method of the preferred embodiments can be stored in air for a while or can be transported without oxidation of the metal surface.

According to preferred embodiments of the second aspect, the metal bond pad can comprise a material selected from the group comprising Al, Al—Cu and Cu, and the wire can comprise a material selected from the group comprising Au, a copper alloy and copper.

According to preferred embodiments of the second aspect, the metal bond pad can comprise Cu and the wire can comprise Au, Cu or Ag.

According to preferred embodiments of the second aspect, the wire can be Cu coated with Au, Cu coated with Pd, Cu coated Ag.

In preferred embodiments of the second aspect, the plasma source can be a direct plasma source.

According to preferred embodiments of the second aspect, the direct plasma source can be formed by a parallel plate with RF.

According to other embodiments of the second aspect, the plasma source can be downstream.

According to preferred embodiments of the second aspect, the hydrogen source can be selected from the group consisting of NH₃, H₂, N₂+H₂, He+H₂, and Ar+H₂.

According to certain embodiments of the second aspect, the method can comprise a further step of masking the semiconductor die structure or wafer to expose the metal bond pad before the hydrogen-plasma production step.

In a third aspect (referred to as a sintering aspect herein), a method for protecting a metal surface is disclosed comprising the steps of providing a substrate comprising a metal surface in a chamber of an oven, heating the substrate to a temperature of from 150° C. to 600° C., more preferably 300° C. to 500° C., still more preferably 400° C. to 450° C. in a reducing gas atmosphere (also called sintering), and removing the substrate from the chamber into an oxidizing environment.

According to preferred embodiments of the third aspect, the reducing gas can comprise H₂, N₂, Ar or He, or other inert gases, or can comprise ammonium plasma (NH₃) or any other gas or gas composition comprising free hydrogen (H₂) or chemically bonded hydrogen (H). Most preferably the reducing gas can be forming gas and can comprise, for example, 4% H₂/N₂, 5% H₂/N₂, 10% H₂/N₂. Also other gas compositions such as, for example, gas compositions comprising 4% H₂/Ar, 5% H₂/Ar or 10% H₂/Ar can be used.

According to preferred embodiments of the third aspect, the reducing gas can comprise only H₂ and N₂.

According to preferred embodiments of the third aspect, the amount of N₂ can be from 98% to 0%. Preferably, the amount of N₂ can be from 98% to 50%.

According to preferred embodiments of the third aspect, the amount of H₂ can be from 2% to 30%, or from 2% to 20%, or from 2% to 15%, or from 2% to 10%.

According to preferred embodiments of the third aspect, the metal surface can be stored in an oxidizing environment for a period of more than 8, 12, 24, 48 hours.

According to preferred embodiments of the third aspect, the oven can be an RTP oven.

According to preferred embodiments of the third aspect, heating the substrate can have a duration from 5 to 60 minutes, more preferably from 10 to 60 minutes, even more preferably from 15 to 25 minutes.

In a fourth aspect, a method for protecting a metal surface is disclosed, comprising treating the metal surface according to the third aspect (sintering aspect), and treating the metal surface according to the first aspect (corresponding to a plasma aspect).

The preferred embodiments also provide the use of the methods for protecting a metal surface in the manufacturing of semiconductor devices.

### BRIEF DESCRIPTION OF THE DRAWINGS

FIG. 1 Illustrates a tool configuration for performing a method according to the prior art (U.S. Pat. No. 6,720,204B2).

FIG. 2 is an Illustration of an embodiment of a device according to a preferred embodiment.

FIG. 3 illustrates an embodiment of a device according to a preferred embodiment.

FIG. 4, FIG. 5 and FIG. 6 demonstrate the wire bonding (WB) performance on a set of wafers subjected to series of different plasma treatments or temperature step (sintering) treatments.

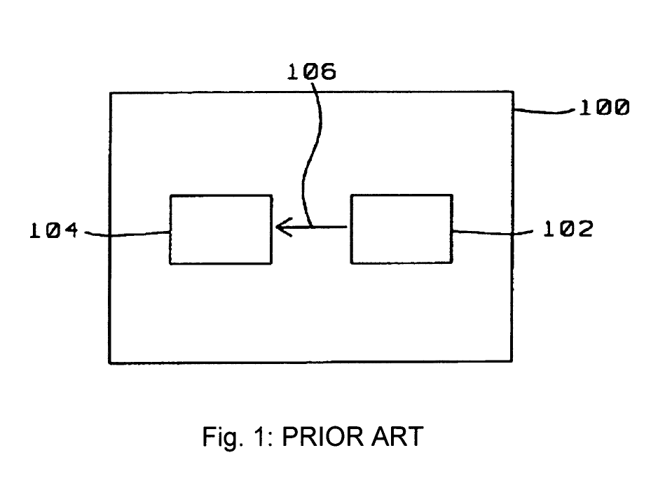

### DETAILED DESCRIPTION OF THE PREFERRED EMBODIMENT

The present invention is described with respect to particular embodiments and with reference to certain drawings but the invention is not limited thereto but only by the claims. The drawings described are only schematic and are non-limiting. In the drawings, the size of some of the elements may be exaggerated and not drawn on scale for illustrative purposes. The dimensions and the relative dimensions do not correspond to actual reductions to practice of the invention.

It is to be noticed that the term “comprising”, used in the claims, should not be interpreted as being restricted to the means listed thereafter; it does not exclude other elements or steps. It is thus to be interpreted as specifying the presence of the stated features, integers, steps or components as referred to, but does not preclude the presence or addition of one or more other features, integers, steps or components, or groups thereof. Thus, the scope of the expression “a device comprising means A and B” should not be limited to devices consisting only of components A and B. It means that with respect to the present invention, the only relevant components of the device are A and B.

The preferred embodiments can be used in any field where metal, as for instance copper, based metallization needs to be protected against oxidation caused by effect of various factors (such as e.g. ambient environment and exposure to elevated temperature).

The preferred embodiments provide methods for protecting metal surfaces against oxidation. The methods according to preferred embodiments reduce metal oxides present at the metal surface by means of a treatment of the metal surface such that, after the treatment, the metal surface is protected against re-oxidation for a certain period of time, even when exposed to an oxidizing environment such as e.g. ambient air.

The preferred embodiments furthermore provide a method for bonding wires on metal bond pads on a wafer. The method comprises pre-treatment of the surface of the wafer using the methods for protecting metal surfaces according to preferred embodiments followed by bonding wires onto the protected metal bond pads.

Typical applications of the methods according to preferred embodiments can be found in the field of metal protection, e.g. copper or copper based alloys protection, of integrated circuits and other components, devices and printed circuit boards (PCB, PWB). The methods can be used during manufacturing of any device where metal, e.g. copper, surface post processing is required (such as wire bonding, soldering, gluing and others).

In the following description the methods according to the preferred embodiments are described for metal bond pads comprising copper. Other metals, however, are though not excluded and can also be used with the preferred embodiments, such as for instance any copper alloy or Ag. Furthermore, the preferred embodiments are described for the bonding wire metal being gold. Again, also here other metals are not excluded and can be used with the preferred embodiments, such as for example Cu, Al, Ag, Pd or any combination of suitable materials such as for example Cu wires coated with Au, Pd or Ag. Table 1 shows some combinations of materials suitable to be used with the preferred embodiments. It has, however, to be understood that these combinations are only examples and are not intended to limit the invention in any way.

TABLE 1
Suitable combinations of metals for forming the bond pad and the wires

| Pad metal | Wire metal |
|---|---|
| Cu | Au |
| Cu | Cu |
| Cu | Cu coated with Au, Pd, Ag |
| Cu | Ag |

In a first aspect, methods for protecting a metal surface, e.g. copper surface, against oxidation are provided. The metal, e.g. copper, surface treatment techniques according to the preferred embodiments restore the oxidized metal surface to a pure metal, e.g. copper, surface and protect it from re-oxidation. This can be achieved in different ways and by different embodiments.

In a first embodiment a high density, H₂ (hydrogen) rich or hydrogen comprising plasma is applied to the metal surface present on e.g. a wafer. When the wafer temperature is above 150° C. the reduction process is complete, or in other words all forms of copper oxides are reduced/removed. Furthermore, above 150° C. the surface is implanted with hydrogen ions which makes it less sensitive to oxidation over a subsequent period of time, as proved by successful wire bonding tests performed at 150° C.

According to a second embodiment a sintering step can be applied, i.e. a temperature step in a reducing gas ambient which comprises hydrogen. The reducing gas can comprise H₂, N₂, Ar or He, or other inert gases, or can comprise ammonium plasma (NH₃) or any other gas or gas composition comprising free hydrogen (H2) or chemically bonded hydrogen (H). Most preferably the reducing gas can be forming gas and can comprise, for example, 4% H₂/N₂, 5% H₂/N₂, 10% H₂/N₂. Also other gas compositions such as, for example, gas compositions comprising 4% H₂/Ar, 5% H₂/Ar or 10% H₂/Ar can be used.

According to a third embodiment a combination of both techniques described in the first and second embodiments can be applied. According to these embodiments, a sintering step can be followed by a plasma treatment or vice versa.

According to a first embodiment, a method is provided for protecting a metal surface against oxidation, the method comprising providing the metal surface within a plasma chamber, producing a hydrogen comprising or hydrogen rich plasma within the plasma chamber, treating the metal surface with the hydrogen comprising or hydrogen rich plasma whereby the metal surface is at a temperature above 150° C. for removing oxides, optionally completely removing oxides present at the metal surface and for hydrogenating the metal surface, and removing the metal surface from the plasma chamber into an oxidizing environment.

According to the first embodiment, the temperature of the metal surface is brought to a temperature of from 30° C. to 400° C., more preferably from 70° C. to 300° C., even more from between 125° C. to 200° C. or from 150° C. to 400° C., preferably from 150° C. to 300° C. and more preferably from 150° C. to 300° C. while treated or before being treated with the hydrogen comprising plasma. In certain embodiments the metal surface can be put on a heatable chuck when in the plasma chamber, which can reduce the process duration.

The hydrogen comprising plasma can be generated by, for example, an Inductively Coupled Plasma-Reactive ion etching or ICP-RIE tool. The power applied to the coil of the ICP-RIE tool, also called ICP parameter, can be from 300 to 1000 W and the direct power or RIE parameter can be from 50 to 250 W. According to other embodiments, the hydrogen comprising plasma can be generated by microwave downstream plasma equipment. The microwave power for downstream plasma can be from 200 to 3000 W.

According to the first embodiment, the hydrogen comprising or hydrogen rich plasma can comprise a small amount of another gas, for example can comprise 10% of e.g. N₂. This N₂ gas or other gases such as e.g. O₂, Ar or He, or other noble gases which can be used in embodiments according to the preferred embodiments and the molecules of which easily dissociate in the plasma, helps the dissociation of H₂ gas into hydrogen ions, which are much more reactive towards the metal, e.g. copper, surface. In addition to the reducing action of the hydrogen comprising or hydrogen rich plasma on the metal oxide, e.g. copper oxide, surface, it can be pointed out that such hydrogen comprising plasma also eliminates fluorines (CF₄, SF₆, . . . ), which are well know to trigger metal corrosion, e.g. copper corrosion, from the surface. It results in a significant improvement of metal, e.g. copper, surface cleanliness.

In case of a H₂/N₂ plasma, the gas flow of the gas in the plasma chamber can, according to preferred embodiments, be 200 sccm for H₂ and 20 sccm N₂, at a pressure of 10 mT, and 600 W ICP, 75 W Bias (plate). The process time or the time the metal, e.g. copper, surface is exposed to the hydrogen comprising or hydrogen rich plasma can be varied from 10 to 120 seconds. Preferably, a process time of from 30 to 120 seconds or of from 60 to 120 seconds can be applied.

According to other preferred embodiments, an H₂/O₂ plasma can be used to clean and passivate the metal, e.g. Cu, surface and protect the metal, e.g. copper, surface against oxidation. According to these embodiments, the gas flow can be 200 sccm for H₂ and 20 sccm for O₂, at a pressure of 10 mT, and a power of 600 W ICP, 75 W Bias (plate), for a process time of from 10 to 120 seconds, 30 to 120 seconds, or 60 to 120 seconds.

The process according to the first aspect reduces metal oxides, e.g. copper oxides, present at a metal surface. Basically, this means that the reducing agent, which according to the first aspect is formed by the hydrogen ions in the hydrogen comprising or hydrogen rich plasma, convert the metal oxide, e.g. copper oxide, back to pure metal, e.g. pure copper. The process simultaneously hydrogenates the copper surface (depth of hydrogenation will mainly depend on power and duration of the plasma treatment) and modifies the surface. This may be explained by hydrogen diffusing into the grain boundaries, and acting later as a barrier toward oxygen, thereby preventing the metal, e.g. Cu, from oxidizing when exposed to oxidizing environment. However the hydrogen ions may also diffuse into the grains. As a result, a long-term oxidation prevention can be obtained which allows storage of the metal surface in normal or ambient atmosphere (comprising e.g. air). This provides an extra degree of process freedom when compared to the prior art, since transportation and waiting cycles between metal, e.g. Cu, surface exposure and further processing such as e.g. wire bonding, are allowed. It is notable that preferably the wire bonding is performed in air at a temperature of from room temperature to 250° C., more preferably from 100° C. to 250° C. during die attach and thermosonic wire bonding (see further).

The method according to the first aspect exhibits several added value features compared to known plasma cleaning and passivation processes prior to wire bonding. Instead of just removing/reducing the oxide, the method according to the first aspect furthermore modifies and conditions the bare metal, e.g. copper, surface. The mechanism of such surface treatment is complex and comprises at least a combination of chemical reactions and physical interactions between the metal, e.g. copper, surface and the hydrogen comprising plasma.

According to a second aspect, an alternative method is provided for protecting a metal surface. The method comprises the steps of providing a wafer or substrate comprising a metal surface in a chamber of an oven, heating the wafer or substrate to a temperature of from 150° C. to 600° C., more preferably 300° C. to 500° C., still more preferably 400° C. to 450° C. in a reducing gas atmosphere; (also called sintering) and removing the wafer or substrate from the chamber into an oxidizing environment.

According to preferred embodiments, the reducing gas can comprise H₂, N₂, Ar or He, or other inert gases, or can comprise ammonium plasma (NH₃) or any other gas or gas composition comprising free hydrogen (H₂) or chemically bonded hydrogen (H). Most preferably the reducing gas can be forming gas and can comprise, for example, 4% H₂/N₂, 5% H₂/N₂, 10% H₂/N₂. Also other gas compositions such as, for example, gas compositions comprising 4% H₂/Ar, 5% H₂/Ar or 10% H₂/Ar can be used.

According to preferred embodiments, the reducing gas can be forming gas and the amount of N₂ in the forming gas can be from 98% to 0%. Preferably, the amount of N₂ can be from 98% to 50%. The amount of H₂ can be from 2% to 30%, or from 2% and 20%, or from 2% to 15%, or from 2% to 10%.

According to preferred embodiments, the oven can be a rapid thermal processing or RTP oven. The temperature step, i.e. the heating of the wafer or substrate, can have a duration of from 10 to 60 minutes, from 50 to 60 minutes, or from 15 to 25 minutes.

Similarly to the process according the first aspect, the process according the second aspect reduces metal oxides, e.g. copper oxides, present at a metal surface. Basically, this means that the reducing agent, which according to the second aspect is formed by the hydrogen ions in the reducing gas, e.g. by the hydrogen ions in the forming gas, convert the metal oxide, e.g. copper oxide, back to pure metal, e.g. pure copper. The process simultaneously hydrogenates the copper surface (depth of hydrogenation will mainly depend on power and duration of the plasma treatment) and modifies the surface. This may be explained by hydrogen diffusing into the grain boundaries, and acting later as a barrier toward oxygen, hereby preventing the metal, e.g. Cu, from oxidizing when exposed to oxidizing environment. However the hydrogen ions may also diffuse into the grains.

As a result, a long-term oxidation prevention, e.g. at least a few hours, e.g. 24 hours, can be obtained which allows storage of the metal surface in normal or ambient atmosphere (comprising e.g. air). This provides an extra degree of process freedom when compared to the prior art, since transportation and waiting cycles between metal, e.g. Cu, surface exposure and further processing such as e.g. wire bonding, are allowed. It is notable that preferably the wire bonding is performed in air at a temperature of from room temperature to 250° C., more preferably from 100° C. to 250° C. during die attach and thermosonic wire bonding (see further).

After being treated with the method according to the second aspect, the metal surface can be stored in an oxidizing environment for a period of more than 8, more than 12, more than 24, more than 48 hours, without suffering from oxidation.

According to a third aspect, another alternative method is provided for protecting a metal surface, the method comprising a combination of the methods described in the first and second embodiment. According to preferred embodiments, the method can comprise first treating the metal surface using the method according to the first aspect (plasma aspect) followed by treating the metal surface using the method according to the second embodiment (sintering aspect). According to other, more preferred, embodiments, the method can comprise first treating the metal surface using the method according to the second aspect (sintering aspect) followed by treating the method according to the first aspect (plasma aspect).

The capabilities of long term oxidation prevention of the plasma treatment and/or sintering according to the first aspect for metal, e.g. copper, bond pads has been tested on electroplated Cu on 200 mm silicon wafers. As a result, metal bonds could successfully be provided to the silicon wafer comprising the electroplated copper at least up to 10 days when the wafer was stored in an N₂ environment and at least up to 1 day when the wafer was exposed in ambient environment without any oxidation removal steps being necessary afterwards before performing a bonding step. With successfully provided is meant that after bonding the wire to the bond pad, a tight contact is obtained between the wire and the bond pad.

The methods described in the above embodiments can be used in processing of e.g. semiconductor devices. More particularly, the methods according to the above-described embodiments can be used for pre-treatment of metal bond pads on e.g. a semiconductor device before wire bonding. Hereinafter, wire bonding is described by means of gold wires. As already mentioned, this is not intended to limit the preferred embodiments in any way and other materials for forming wires can also be used with the preferred embodiments.

In a second aspect, a method is provided for bonding a wire to a metal bond pad on a wafer. The method comprises treating the metal bond pad with the method according to any of the first, second or third embodiments and bonding a wire to the metal bond pad after having moved the wafer with the metal bond pad into an oxidizing environment.

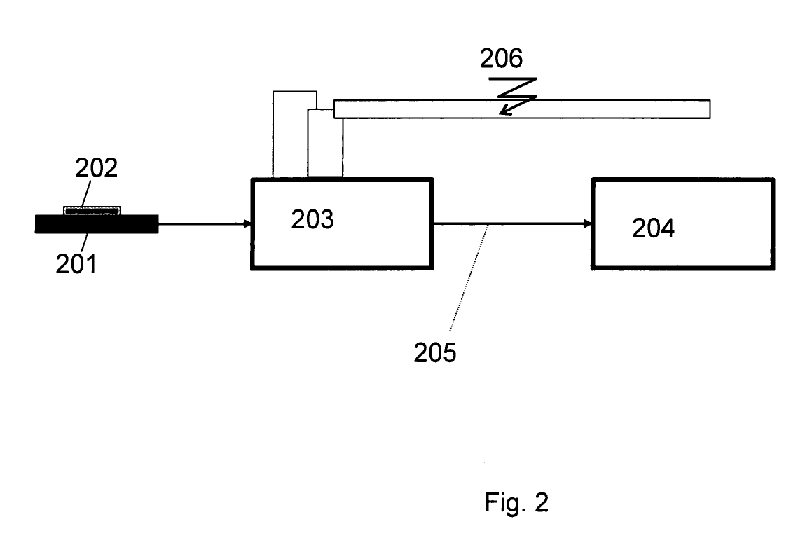

FIG. 2 illustrates an embodiment of a tool which can be used for performing the method according to the second aspect by using the method according to the first embodiment. A wafer 201 comprising metal bond pads 202 is first provided into a plasma chamber 203 where it is treated using the method according to the first embodiment. Before the wafer 201 is transported to wire bonding equipment 204 (indicted by arrow 205), it can be stored in an oxidizing environment such as e.g. a storage room 206.

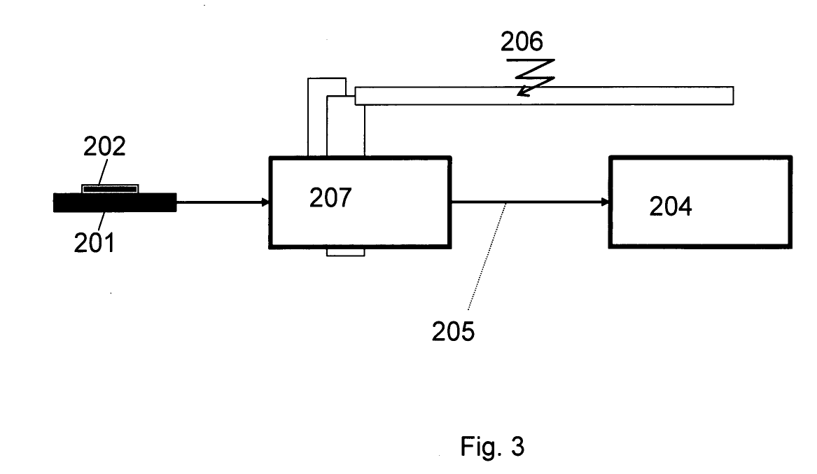

FIG. 3 illustrates an embodiment of a tool which can be used for performing the method according to the second aspect by using the method according to the second embodiment. The tool is similar to the tool illustrated in FIG. 2 but the plasma chamber 203 is now replaced by an oven 207, for example an RTP oven.

Ultrasonic gold wire bonding is used to evaluate the effectiveness of the proposed sintering and/or plasma treatment techniques of the above-described embodiments. It has to be understood that this is only for an example and that other metals can also be used for the wire bonding.

Ball bonds were provided on the metal bond pads. Non-treated wafers showed a large number of non-stick ball bonds up to 90% (failed bonds), in comparison to 100% effective bonds realized on wafers treated using the method according to the first, second or third aspects. According to experiments, plasma conditions (such as gas ratios, time, power) may be influencing the bondability of the metal, e.g. copper, surface. For the bonding performance evaluation the following criteria have been used:
Amount of non-stick bond balls
Ball shear force and Bond Shear Strength (=Ball shear force normalized by bond area value)
Ball diameter and ball shape
Bond performance time dependency

According to preferred embodiments, wire bonding was carried out on a standard Wire Bonder (Delvotec 6200) equipped with a 60 kHz transducer. A gold wire for general bonding application of 25 μm diameter was used. Three level Design of Experiments (DOE,=experimental matrix) experiments with different bonding parameters (ultrasonic power, ultrasonic time and bonding force) were carried out to bond gold wire onto a plasma treated and/or sintered copper surface. Bond force, bond time and ultrasonic (US) power were varied for the process of wire bonding, whereas other parameters and settings were constant during all series of experiments. The bonding temperature was set to 150° C. for all experiments. A bonding capillary for general wire bonding application with an 80 face angle (FA), 90° chamfer angle (CA) and a 100 μm tip was chosen.

As a result of plasma treatment according to the first aspect, or sintering treatment according to the second aspect, or combined method according to a third aspect, for protecting a metal surface against oxidation, the metal, e.g. copper, bond pads remain substantially oxide-free. With substantially oxide-free is meant that the degree of re-oxidation is low enough to allow a good wire bonding on the metal surface without any oxidation removal steps being necessary before the bonding step. With good wire bonding is meant that after bonding the wire to the bond pad, a tight contact is obtained between the wire and the bond pad. This is for the whole period between starting the whole wafer's life time cycle, wafer's storage, up to completion of wire bonding process. It was evidenced that metal, e.g. copper, surfaces treated in such way exhibited enhanced resistance to oxidation during at least 1 day storage in ambient environment.

This means it can easily be stored in ambient or normal atmosphere conditions for 1 hour, 4 hours, 8 hours, 12 hours, 18 hours, 24 hours, 2 days or more. This is the case for metal surfaces treated by using the plasma treatment (first embodiment) or by using the sintered treatment (second embodiment) or by using the combination treatment (third embodiment).

If a very small amount of oxide is present on the metal bond pad, it does not negatively influence the wire bonding anymore. Very thin oxides do not prevent successful or good wire bonding to the wafer. The thicker the oxide on the wafer becomes, the more difficult wire bonding is. Fresh Cu (as deposited onto the wafer) can have an oxide thickness of about 1 to 5 nm, which may still allow successful wire bonding. After deposition, the oxide grows rapidly and as from an oxide thickness of about 20 to 50 nm it may no longer be possible to obtain successful wire bonding to the wafer because of the too thick oxide being present.

An advantage of the method according to preferred embodiments is that a long term prevention of metal or metal based alloys as copper and copper based alloys from oxidation is achieved. This while the metal or metal based alloys as copper and copper based alloys are brought in an oxidizing environment. The storage life, self life, and thermal stability of metal surfaces are improved. There is no metal, e.g., copper, consumption during surface treatment.

The plasma technique according to the first embodiment can be performed at CMOS compatible temperatures, which are e.g. lower than 450° C., or lower than 420° C., or lower than 400° C., or lower than 350° C., depending on the application.

No foreign layer on top of the bond pad is required to perform metal protection, e.g. copper protection.

The method still allows and is suitable for thermosonic wire bonding techniques. Moreover it is easy to integrate into existing factory automation platforms.

Experiments

Table 2 illustrates the different condition sets used during experiments.

TABLE 2
Different treatment condition sets

| Wafer's set | Plasma treatment | Sintering |
|---|---|---|
| 1 | 10s H₂/N₂ | No |
| 2 | 30s H₂/N₂ | no |
| 3 | 60s H₂/N₂ | no |
| 4 | 120s H₂/N₂ | no |
| 5 | 120s H₂/N₂ | 420° C. |
| 6 | no | 420° C. |
| 7 | no treatment | no |

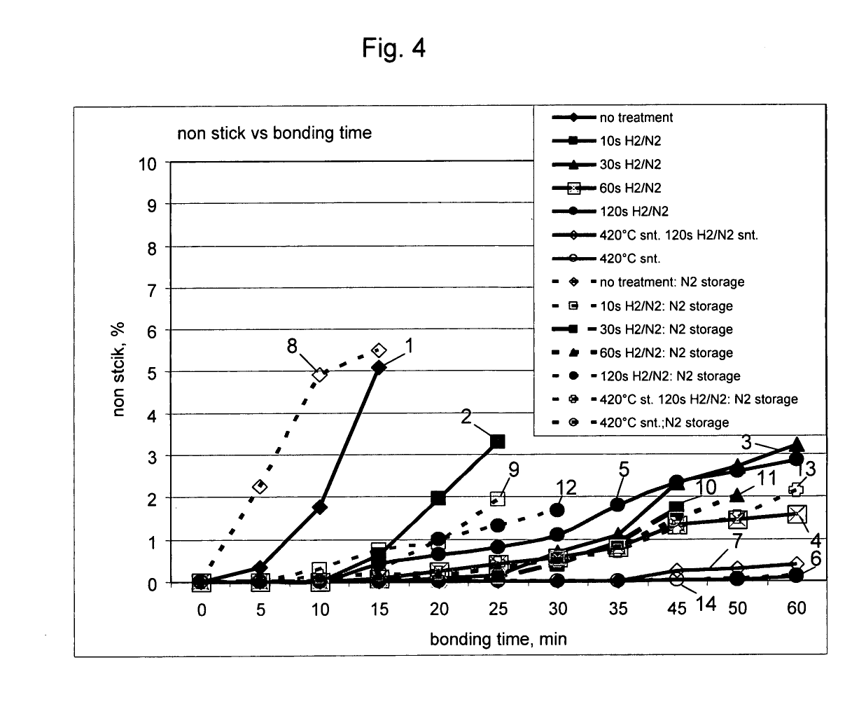

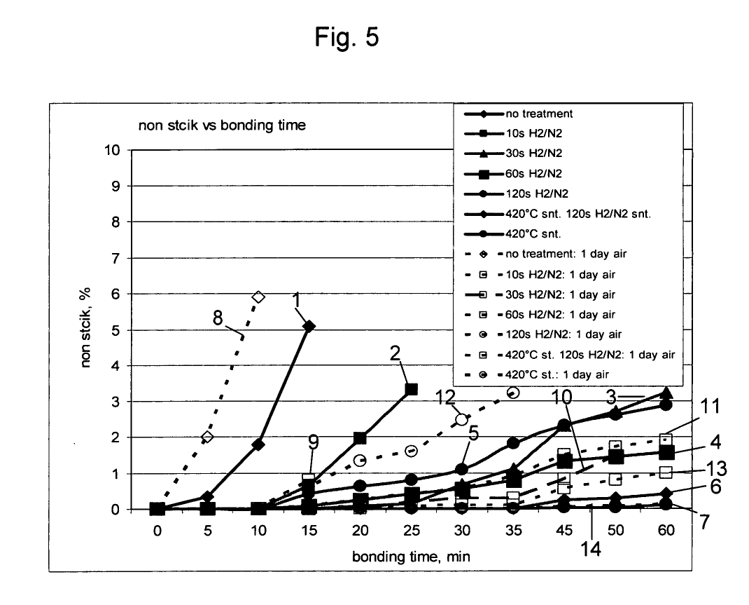

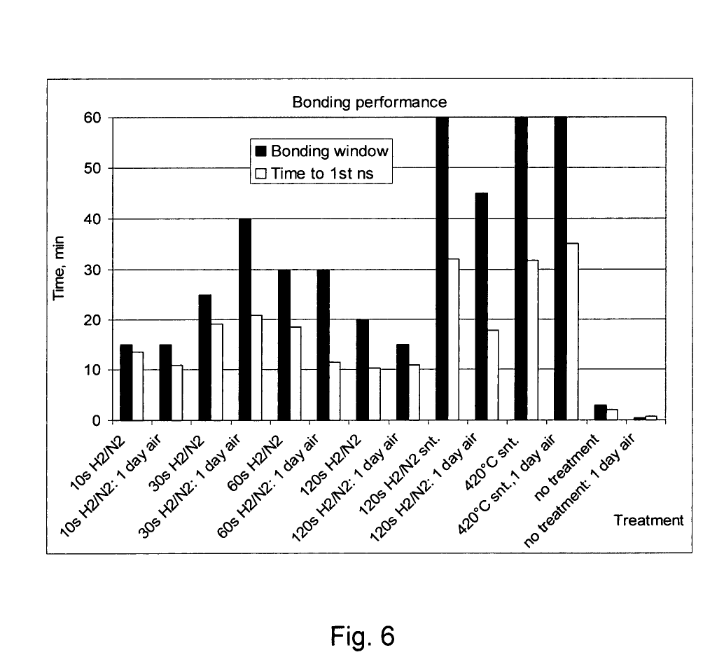

Results of bonding performance on non-treated samples are also plotted for reference purpose only (see FIG. 4).

Bonding performance was assessed in terms of non-stick bond balls occurrence (non-stick percentage). Non-stick, or bonds not sticking on the die, is a typical failure used for wire bonding process characterisation.

All plasma treated samples (according to the first embodiment) are performing much better than non-treated samples. Also differentiation between plasma treated samples has been observed. Non-treated samples (curve 1 in FIG. 4 and FIG. 5) have an order of magnitude larger amount of non-stick bond balls compared to samples treated in plasma only during 10 sec (curve 2 in FIG. 4 and FIG. 5). After 15 min. bonding the sample treated in plasma (according to the first embodiment) has 0.5% non-stick bond balls, whereas the non-treated sample has more than 5% non-stick bond balls, and for the best plasma treatment condition (i.e. for the plasma treatment after 30 and 60 sec. (respectively curve 3 and 4 in FIG. 4 and FIG. 5)) even 0% non-stick was encountered.

Increase plasma treatment duration from 10 sec to 60 sec results in an enhanced bonding performance; the amount of non-stick bond balls significantly decreases. Optimum bonding performance was demonstrated for the following plasma treatment conditions (see table 2): 2 (30 sec) and 3 (60 sec) (see respectively curve 3 and 4 in FIG. 4 and FIG. 5). Based on that, it can be concluded that plasma treatments of a duration of from 30 (curve 3 in FIG. 4 and FIG. 5) to 120 (curve 5 in FIG. 4 and FIG. 5) seconds, more preferably from 30 (curve 3 in FIG. 4 and FIG. 5) to 60 sec (curve 4 in FIG. 4 and FIG. 5) are the most interesting from practical point of view and give the best wire bonding performance, whereas further increasing the plasma treatment duration did not bring any performance improvement and saturation followed by deterioration bonding performance. Bonding performance after 120 sec (curve 5 in FIG. 4 and FIG. 5) of plasma treatment is worse than bonding performance after 30 and 60 sec of plasma treatment respectively (see respectively curve 3 and 4 in FIG. 4 and FIG. 5). The plasma treatments of a duration of 60 to 120 seconds can also be preferred in certain embodiments.

Influence of wafer's storage at inert atmosphere (10 days in N₂) on bonding performance has been studied. The dashed series of lines on FIG. 4 (curves 8 to 14) illustrate bonding performance on the wafer's set (table 2) additionally to plasma treatment according to the first embodiment subjected to storage during 10 day at N₂ environment. Storage at N₂ deteriorates bonding on non-treated wafers (curve 8); contrary to that it does bring significant changes in bonding performance on plasma treated wafers (curve 9 (10 sec), curve 10 (30 sec), curve 11 (60 sec) and curve 12 (120 sec)), in accordance with the preferred embodiments. Based on that observation it is concluded that proper storage conditions will not change wafer's bonding performance.

Bonding performance on wafers directly after plasma treatment and after 24 h air exposure (dashed lines in FIG. 5, curves 8 to 14) has also been compared. On all treated samples, except at 10 sec (curves 9 to 14 in FIG. 5), a slight difference is observed for plasma treated samples (curve 9 (10 sec), curve 10 (30 sec), curve 11 (60 sec) and curve 12 (120 sec)), however it is within an error range of ±1%.

Significant deterioration occurred on non plasma treated wafers (curve 8 in FIG. 5) and a quite remarkable difference is obtained with regard to 10 sec plasma treated wafers (curve 9 in FIG. 5).

On FIGS. 4 and 5 additionally to the results for plasma treated samples, results for samples subjected to sintering (table 2) were plotted. These samples in terms of non-stick bond ball features yield still much better as any plasma treated sample. Also they demonstrated excellent resistance to N₂ storage (see curve 14 in FIG. 4) and 1 day exposure to air (see curve 14 in FIG. 5). Samples treated with both the plasma treatment (first embodiment) and sintering treatment (second embodiment) showed very good non-stick bond ball characteristics both directly after treatment (see curve 6 in FIG. 4 and FIG. 5) and after 1 day storage in air (see curve 13 in FIG. 5).

FIG. 6 describes bonding performance in terms of a bonding window and time to first non-stick.

“Time to first non-stick” is a bonding response solely caused by wafer conditions excluding any visual surface defects and contamination except defects due to thermal metal, e.g. copper, oxidation and/or any degradation phenomena or phenomena related to these processes, and is a time when the first non-stick occurs.

The “bonding window” is a bonding response solely caused by wafer conditions; it is a time period in which only a specified amount of non-stick events may occur.

Bonding performance in terms of “Time to first non-stick” and “Bonding window” have similar trends. Non-treated samples have very short bonding windows and first non-stick occurs very early. From practical point of view non-treated samples are not suitable for wire bonding, whereas already a short plasma treatment of 10 sec improves bonding performance significantly. Samples treated during 30 to 60 sec have the largest bonding window. Sintered samples exhibit even a broader window.

All references cited herein are incorporated herein by reference in their entirety. To the extent publications and patents or patent applications incorporated by reference contradict the disclosure contained in the specification, the specification is intended to supersede and/or take precedence over any such contradictory material.

The term “comprising” as used herein is synonymous with “including,” “containing,” or “characterized by,” and is inclusive or open-ended and does not exclude additional, unrecited elements or method steps.

All numbers expressing quantities of ingredients, reaction conditions, and so forth used in the specification and claims are to be understood as being modified in all instances by the term “about.” Accordingly, unless indicated to the contrary, the numerical parameters set forth in the specification and attached claims are approximations that may vary depending upon the desired properties sought to be obtained by the present invention. At the very least, and not as an attempt to limit the application of the doctrine of equivalents to the scope of the claims, each numerical parameter should be construed in light of the number of significant digits and ordinary rounding approaches.

The above description discloses several methods and materials of the present invention. This invention is susceptible to modifications in the methods and materials, as well as alterations in the fabrication methods and equipment. Such modifications will become apparent to those skilled in the art from a consideration of this disclosure or practice of the invention disclosed herein. Consequently, it is not intended that this invention be limited to the specific embodiments disclosed herein, but that it cover all modifications and alternatives coming within the true scope and spirit of the invention as embodied in the attached claims.

What is claimed is:

1. A method for protecting a metal surface, the method comprising the steps of:
a. providing a metal surface within a plasma chamber;
b. producing a hydrogen-comprising plasma within said plasma chamber;
c. treating said metal surface with said hydrogen-comprising plasma, whereby the metal surface is heated to a temperature above 150° C. to remove oxides present at the metal surface and to hydrogenate the metal surface; and
d. removing said metal surface from said plasma chamber into an oxidizing environment.

2. A method according to claim 1, wherein the temperature is from 150° C. to 400° C.

3. A method according to claim 1, wherein said metal surface comprises a metal selected from the group consisting of Cu and Ag.

4. A method according to claim 1, wherein said plasma is formed from a plasma gas, the plasma gas comprising at least one of H₂ and NH₃.

5. A method according to claim 4, wherein a fraction of plasma gas comprising at least one of H₂ and NH₃ is from 100% to 20% of the plasma gas.

6. A method according to claim 1, wherein said plasma is formed from a plasma gas, the plasma gas comprising at least one gas selected from the group consisting of N₂, O₂, Ar, He, and other noble gases.

7. A method according to claim 6, wherein a fraction of plasma gas comprising at least one gas selected from the group consisting of N₂, O₂, Ar, He, and other noble gases is from 0% to 30%.

8. A method according to claim 1, wherein the method further comprises storing said metal surface in an oxidizing environment for a period of more than 24 hours.

9. A method according to claim 1, wherein the hydrogen-comprising plasma is generated by an inductively coupled plasma—reactive ion etching device.

10. A method according to claim 9, wherein a power supplied to a coil of the inductively coupled plasma—reactive ion etching device is from 300 W to 1000 W.

11. A method according to claim 9, wherein a direct power parameter of the inductively coupled plasma—reactive ion etching device is from 50 W to 250 W.

12. A method according to claim 1, wherein said hydrogen-comprising plasma is generated by microwave downstream plasma equipment.

13. A method according to claim 12, wherein a power for the microwave downstream plasma equipment is from 200 W to 3000 W.

14. A method according to claim 1, wherein treating said metal surface with said hydrogen-comprising plasma has a duration of from 30 seconds to 120 seconds.

15. A method according to claim 1, wherein an injection of gas into the plasma chamber for forming the plasma has a flow of from 50 sccm to 600 sccm.

16. A method for protecting a metal surface comprising the steps of
a. providing a substrate comprising a metal surface in a chamber of an oven;
b. heating the substrate to a temperature of from 150° C. to 600° C., in a reducing gas atmosphere; and
c. removing said substrate from said chamber into an oxidizing environment.

17. A method according to claim 16, wherein the reducing gas comprises at least one substance selected from the group comprising free hydrogen and chemically bonded hydrogen.

18. A method according to claim 16, wherein said reducing gas comprises at least one gas selected from the group consisting of H₂, N₂, Ar, He, NH₃, and other inert gases.

19. A method according to claim 16, wherein said forming gas consists of at least one gas selected from the group consisting of H₂ and N₂.

20. A method according to claim 19, wherein an amount of N₂ in the forming gas is from 98% to 0%.

21. A method according to claim 19, wherein an amount of H₂ in the forming gas is from 2% to 30%.

22. A method according to claim 20, wherein said amount of H₂ is from 2% to 30%.

23. A method according to claim 16, further comprising storing said metal surface in an oxidizing environment for a period of more than 24 hours.

24. A method according to claim 16, wherein said oven is a rapid thermal process oven.

25. A method according to claim 16, wherein the step of heating the substrate has a duration of from 5 minutes to 60 minutes.

26. A method for protecting a metal surface, the method comprising:
a. treating the metal surface using a method comprising providing a substrate comprising a metal surface in a chamber of an oven; heating the substrate to a temperature of from 150° C. to 600° C., in a reducing gas atmosphere; and removing said substrate from said chamber into an oxidizing environment; and
b. treating the metal surface using a method according to claim 1.

27. Use of the method according to claim 1 in the manufacture of a semiconductor device.

28. Use of the method according to claim 16 in the manufacture of a semiconductor device.

29. Use of the method according to claim 26 in the manufacture of a semiconductor device.

30. A method for bonding a wire to a metal bond pad on a wafer, the method comprising the steps of:
a. treating the metal bond pad using the method according to claim 1; and
b. bonding a wire to said metal bond pad after having moved said wafer into an oxidizing environment.

31. A method for bonding a wire to a metal bond pad on a wafer, the method comprising the steps of:
a. treating the metal bond pad using the method according to claim 16; and
b. bonding a wire to said metal bond pad after having moved said wafer into an oxidizing environment.

32. A method for bonding a wire to a metal bond pad on a wafer, the method comprising the steps of:
a. treating the metal bond pad using the method according to claim 26; and
b. bonding a wire to said metal bond pad after having moved said wafer into an oxidizing environment.

33. The method according to claim 30, wherein said metal bond pad comprises a material selected from the group consisting of Al, Al—Cu, and Cu, and wherein said wire comprises a material selected from the group consisting of Au, Ag, a copper alloy, and copper.

34. The method according to claim 30, wherein said wire comprises Cu coated with Au, Cu coated with Pd, or Cu coated Ag.

35. The method of 30, further comprising the step of masking said wafer to expose said metal bond pad before said hydrogen-plasma production step.
